(19) United States
(12) Patent Application Publication
(10) Pub. No.: US 2006/0016681 A1
(43) Pub. Date: Jan. 26, 2006

(54) Apparatus and method for separating tritated and heavy water from light water via a conical configuration

(76) Inventor: Boris J. Muchnik, Superior, CO (US)

Correspondence Address: GREENBERG & LIEBERMAN, 314 PHILADELPHIA AVE., TAKOMA PARK, MD, 20912, US

(21) Appl. No.: 11/022,214

(22) Filed: Dec. 23, 2004

Related U.S. Application Data
(63) Continuation of application No. 10/710,071, filed on Jun. 16, 2004.

(51) Int. Cl. C02F 1/04; B01D 3/14

(52) U.S. Cl. 202/182; 203/10; 203/31

(57) ABSTRACT

An system for separating tritiated water from common water, using gravity and the freezing point of tritiated water to cause tritiated water to freeze along the inside of a conically-shaped collection chamber. The common water and liquid tritiated water that pass out the bottom of the conically-shaped collection chamber are pumped back to the top of the conically-shaped collection chamber for repeated runs until sufficient tritiated water has frozen to the inside of the conically-shaped collection chamber. A water wheel is positioned to assist in powering the pump that drives water through repeated runs.

### FIELD OF THE INVENTION

An apparatus and method for separating tritiated water (HTO) and/or heavy water (D₂O) from light water (H₂O). Water contaminated with tritium is produced as a by-product of nuclear power plants and is a substantial problem due to the detrimental affects of tritiated water on living organisms and the environment. The method of separation prescribed herein is intended to reduce the concentration of tritiated water in a volume of contaminated light water rather than fully separating the tritiated water from the light water.

### BACKGROUND OF THE INVENTION

Nuclear power plants must regularly contend with the disposal and storage of tritiated water. Traditionally the triated water is either stored in drums for 10 times its half life (120 years) or it is dispersed into the local streams and environment, hopefully in small enough quantities to create a minimum of havoc on the local ecology, including the humans living in the area. However, it is believed by many that any amount of tritiated water is detrimental to living beings and that it is the primary source of cancer in today's society. Therefore an alternate method of disposal of tritiated water is required.

Many other inventions deal with this subject matter and attempt to solve this problem. However none, before now, have been successful in creating a method that is both effective and economically feasible. For instance:

U.S. Pat. No. 5,954,968 APPARATUS AND METHOD FOR SEPARATING HEAVY ISOTOPES OF HYDROGEN FROM HEAVY WATER issued on 1999-Sep.-21 by Patterson, James A. attempts to separate the HW from the LW by passing the mixture (heavy and light water mixed) through an elongated length of hollow core fiber which is formed of cellulose acetate, thereby attempting to filter out the HW. This method does, to some degree reduce the level of HW in the resulting mixture, but not to a great degree and the hollow fiber is thereafter no longer usable and must be discarded in an equally careful fashion as the original mixture. This of course creates a larger mass of substance which is contaminated with HW and which must be stored or discarded in some fashion.

U.S. Pat. No. 6,190,531 CONCENTRATION AND REMOVAL OF TRITIUM AND/OR DEUTERIUM FROM WATER CONTAMINATED WITH TRITIUM AND/OR DEUTERIUM issued on 2001-Feb.-20 by Meyer, Thomas J.; Narula, Poonam M.; attempts to solve the problem by converting the HTO or HDO into an organic substrate, followed by electrolysis of said subtrate while in the presence of metal oxo complexes thereby oxidizing the protio form of the substrate thereby creating hydrogen gas, and thereby concentrating the heavy isotopes in the water from which it can be subsequently removed. This method is complex, inefficient, expensive, not very effective and rather dangerous. The complexity and expense are of course tied together. It is dangerous because it places a radioactive substance in to a gaseous pressurized form that can accidentally be let out into the atmosphere to the detriment of any body down wind. It is not very effective as it takes a considerable period of time to separate a small amount of the tritium or deuterium when there is a very large quantity that needs to be processed.

U.S. Pat. No. 6,153,092 APPARATUS FOR SEPERATING HEAVY IOSOTOPES OF HYDROGEN FROM WATER issued on 2000-Nov.-28 by Patterson, James A.; Gruber, Martin Josef; Furlong, Louis Edward; is similar to the prior patent except in that the hollow core fibers is filled or packed with small beads that are made up of porous exchange resin. It has all of the same disadvantages of as the prior patent.

U.S. Pat. No. 6,203,483 METHOD FOR SOLVENT EXTRACTION WITH NEAR-EQUAL DENSITY SOLUTIONS issued on 2001-Mar.-20 by Birdwell, Joseph F.; Randolph, John D.; Singh, S. Paul; is a method for the separation of liquids of near equal density using a modified centrifugal contractor with a means for creating a pressure differential between the inside of the rotor and the heavy phase solution outlet. This separation method will not separate heavy and light water, as when they are in the aqueous state their density is exactly the same.

U.S. Pat. No. 5,858,199 APPARATUS AND METHOD FOR ELECTROCORIOLYSIS THE SEPARATION OF IONIC SUBSTANCES FROM LIQUIDS BY ELECTROMIGRATION AND CORIOLIS FORCE issued on 1999-Jan.-12 by Hanak, Joseph J. is a method for separating ionizable compounds out of liquids, such as water, through the use of electromigration (electrolytic or electrostatic increasing the weight of the ionized substances) and thereby separating out said substances through the use of the coriolis effect. This method has many similarities to the current invention in that it takes advantage of a natural process to increase the weight of a substance, which can then be more easily separated from the water. This method is of course ineffective for the separation of heavy water from light water in that the electrolytic and electrostatic affects only the chemical makeup of the mixture and does not affect the nuclear. It therefore is completely ineffective on a mixture of heavy and light water which when in an aqueous state act in the react in the same fashion to electricity.

U.S. Pat. No. 5,451,322 METHOD AND APPARATUS FOR TRITIATED WATER SEPARATION issued on 1995-Sep.-19 by Nelson, David A.; Duncan, James B.; Jensen, George A.; is a membrane method for separating heavy water from light water where the mixture is placed under pressured and forced through a polyphosphazene polymer based membrane. This method has the negative of being very expensive, very complicated (and therefore slow) and because the resulting reaction is exothermic can create a high-pressure system with all of its incumbent hazards.

U.S. Pat. No. 4,411,755 LASER-ASSISTED ISOTOPE SEPARATION OF TRITIUM issued on 1983-Oct.-25 by Herman, Irving P., Marling, Jack B. catalytically reacting the heavy light water mixture in an exchange reaction with XYD to produce XYT; irradiating said resulting mixture with a laser thereby dissociating the molecules to x+YT and then chemically separating the YT there from. It is costly, slow, and a high pressure system and as such is dangerous and very complicated requiring expensive equipment.

The subject matter of Tritium Isotope Separation is discussed more fully in Dr. Gheorge Vasaru's book on the subject, which is incorporated herein by reference. The book discusses all of the above methods and is considered to be compendium of all knowledge on the subject to date. It is of course hoped and believed that the subject patent will merit a further chapter in his next update on the subject.

Thus, there is a need for a method to effectively separate tritiated water from common water. Further, it is desirable that the method be energy efficient.

### SUMMARY OF THE INVENTION

The present invention employs melting points of common water and tritiated water or other types of heavy water. The tritiated water or other types of heavy water is frozen and allowed to separate within the common water mixture. The common water is then removed from the tritiated water or other types of heavy water.

The method involved is the simplest of methods and relies on the fact that tritiated water freezes at a different temperature than that of light water, i.e. the melting point of the tritiated water is higher than light water by 4.49 degrees Celsius. The present invention proposes an inverted conically-shaped collection chamber that is maintained at 4.49 degrees Celsius. Within the collection chamber a combination of tritiated water and common water is poured. The tritiated water freezes before the common water so while the tritiated water freezes alongside the interior of the collection chamber, the common water merely flows down the interior of the collection chamber because the collection chamber is not cold enough for the common water to freeze. The common water and any unfrozen tritiated water is then passed out of the collection chamber. Via a pump and/or other means, the common water and any unfrozen tritiated water is moved back to the top of the collection chamber. Next, the unfrozen tritiated water and common water are run through the collection chamber time after time in the fashion aforementioned, in repeated cycles, until most or all tritiated water remains frozen within the collection chamber.

The collection chamber can be warmed when removal of the tritated water is desired, such that the frozen tritiated water will simply melt and flow out the bottom of the collection chamber for disposal and/or storage.

### BRIEF DESCRIPTION OF THE DRAWING

FIG. 1 shows the apparatus employed in the present invention.

### DETAILED DESCRIPTION

Definitions

Heavy water—Where one of the hydrogen atoms in normal water has been replaced by a heavier isotope such as tritium in the case of tritiated water (HTO) or deuterated water (D₂O). It is created in small quantities in nature when cosmic rays interact with nitrogen in the upper atmosphere. These rays interact with nitrogen (¹⁴N) or with deuterium (²H) and form tritium and carbon (¹²C). As these interactions happen in the upper atmosphere the tritium falls to earth in rainfall. It is created in large quantities in nuclear power plants when the inner ring of water being used as a coolant is bombarded with neutrons in a nuclear reactor or an accelerator.

Light Water—Normal water—H₂O

Tritium—is a radioactive element. The tritium atom (³H) is unstable because it has two extra neutrons in its nucleus. These neutrons give tritium an excess amount of energy. Because of this, the atom will undergo a nuclear transformation or radioactive decay. In this, the atom emits two radiations: a beta particle (β⁻), which is similar to an electron, and an anti-neutrino.

Deuterium—2H is a stable isotope of hydrogen. The nucleus of deuterium (called a deuteron) has one proton and one neutron, whereas a normal hydrogen nucleus just has one proton. Deuterium is also called heavy hydrogen.

Isotope—Isotopes are atoms of a chemical element whose nuclei have the same atomic number, Z, but different atomic weights, A.

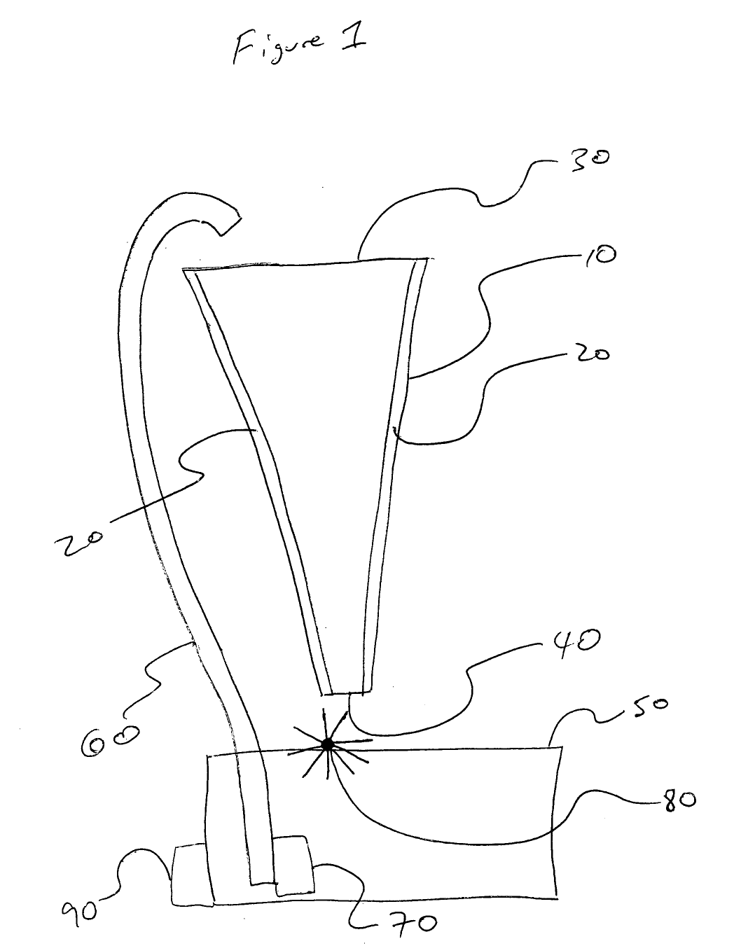

The present invention has a collection chamber (10) which is maintained at a temperature of 4.49 degrees Celsius. In the preferred embodiment, a conventional refrigeration system is employed to maintain the collection chamber (10) at a constant temperature of 4.49 degrees Celsius. The interior of collection chamber (10) is hollow, such that, as shown in cross-section view FIG. 1, the walls (20) of collection chamber (10) provide a surface for anything poured in open top end (30) of collection chamber (10) to adhere to. The bottom end (40) of collection chamber (10) is also open.

A mixture of tritiated water and common water is deposited into open top end (30) and the tritiated water, because it freezes at a temperature of 4.49 degrees Celsius, adheres to the walls (20) as gravity pulls the tritiated water down through collection chamber (10). The common water, however, because it freezes at 0 degrees Celsius, does not adhere to the walls (20). Thus, the present invention provides an effective method for separating the tritiated water from the common water via employing the freezing points of tritiated water versus common water. Any remaining liquid tritiated water and common water then falls from collection chamber (10) into bin (50) via bottom end (40).

Because one pass of the tritiated water and common water through the collection chamber (10) might not be sufficient to remove the desired amount of tritiated water from the common water, any remaining liquid tritiated water and common water can be pumped back atop collection chamber (10) via a conventional pathway (60). A conventional pump (70) provides the means by which any remaining liquid tritiated water and common water can be pumped back atop collection chamber (10) via a conventional pathway (60).

To conserve power, the present invention has a waterwheel (80) that powers generator (90) which, in turn, powers conventional pump (70). As the common water and liquid tritiated water falls from bottom end (40), the common water and liquid tritiated water moves waterwheel (80). Although no device can run without some loss of power, the waterwheel (80) at least counts against the total amount of power required by conventional pump (70). All devices employed in the present invention, such as but not limited to waterwheel (80), generator (90), and pump (70) communicate via conventional electrical connections.

Once a build up of frozen tritiated water has occurred on walls (20), pathway (60) is directed away from collection chamber (10) and into another vessel because. Thus, common water and any remaining liquid tritiated water can be stored in that other vessel. Next, collection chamber (10) can be warmed so that the frozen tritiated water will simply melt off the walls (20) and fall into bin (50), and the tiritiated water in bin (50) can be disposed of.

The present invention is not limited to the embodiment described, but has all embodiments within the scope of the following claims.

I claim:

1. An apparatus for separating tritiated water from common water, comprising:
A conically-shaped collection chamber;
A means for cooling said collection chamber to 4.49 degrees Celsius; and
A bin, under said conically-shaped collection chamber.
